(19) United States
(12) Patent Application Publication
(10) Pub. No.: US 2026/0157570 A1
(43) Pub. Date: Jun. 11, 2026

(54) COOKING APPARATUS FOR MOVING FOOD WHILE DEEP FRYING

(71) Applicant: Wilson Gaw, Houston, TX (US)

(72) Inventor: Wilson Gaw, Houston, TX (US)

(21) Appl. No.: 18/969,541

(22) Filed: Dec. 5, 2024

(51) Int. Cl. A47J 37/12

(52) U.S. Cl. CPC A47J 37/1214; A47J 37/1219; A47J 37/1247; A47J 37/1261; A47J 37/1266; A47J 37/1295

(57) ABSTRACT

A cooking apparatus for rotating and mixing food while frying the food in oil includes a vessel configured to contain cooking oil. A heating assembly is mounted to the vessel and is configured to heat the cooking oil. A food container is provided which is movable with respect to the vessel. The food container comprises a frame, and a fryer basket rotatably mounted to the frame. The fryer basket defines an interior volume in the fryer basket and also defines a plurality of holes which extend through the basket into the interior volume. The food container is positionable in a cooking position in which the fryer basket is positioned in the vessel.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to oil-frying cooking apparatuses and more particularly pertains to a new oil-frying cooking apparatus for rotating and mixing food while frying the food in oil.

### (2) Description of Related Art Including Information Disclosed Under 37 CFR 1.97 and 1.98

The prior art describes oil-frying cooking apparatuses which use a rotating drum to flip and mix food during a frying process such that all sides of the food are cooked and foods are prevented from sticking to each other such that surfaces would not be exposed to the cooking oil used. U.S. Pat. No. 5,543,166 describes such an apparatus with a rotating drum which automatically elevates out of the cooking oil when the cooking process is completed via springs. However, the prior art fails to describe such an apparatus in which such a drum is movable with respect to the vessel holding the cooking oil via a hoist and a carriage-and-track assembly.

### (h) BRIEF SUMMARY OF THE INVENTION

An embodiment of the disclosure meets the needs presented above by generally comprising a vessel with a base wall and a perimeter wall. The perimeter wall is coupled to and extends away from the base wall, and the vessel defines a cavity which is surrounded by the base wall and the perimeter wall. The vessel is configured to contain cooking oil in the cavity. A heating assembly is mounted to the vessel and is configured to heat the cooking oil. A food container is provided which is movable with respect to the vessel. The food container comprises a frame, and a fryer basket rotatably mounted to the frame. The fryer basket defines an interior volume in the fryer basket and also defines a plurality of holes which extend through the basket into the interior volume. The food container is positionable in a cooking position in which the fryer basket is positioned in the cavity of the vessel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a cooking apparatus according to an embodiment of the disclosure.

FIG. 2 is a rear view of an embodiment of the disclosure.

FIG. 3 is a side view of an embodiment of the disclosure.

FIG. 4 is a top view of a vessel and a heating assembly of an embodiment of the disclosure.

### (J) DETAILED DESCRIPTION OF THE INVENTION

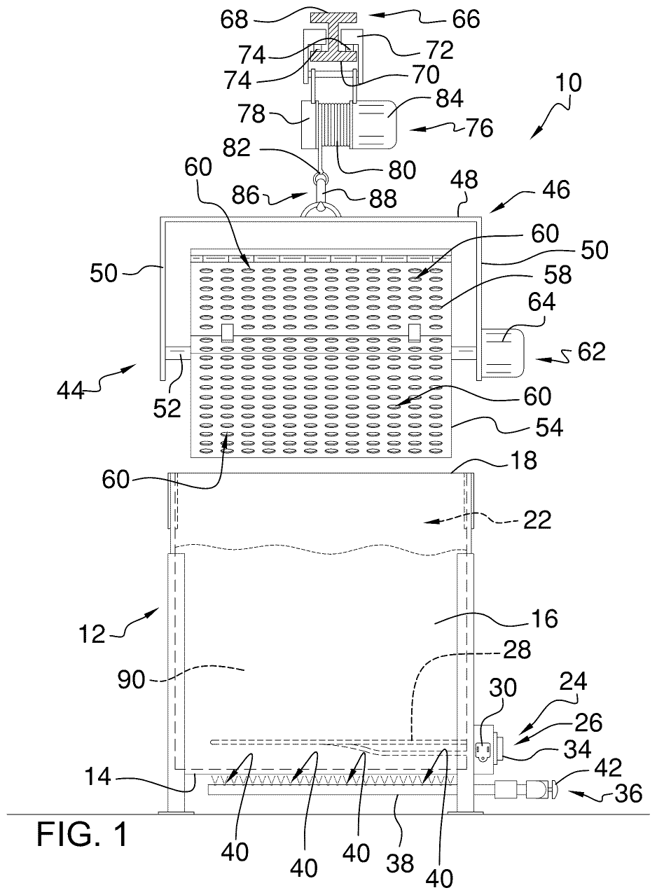

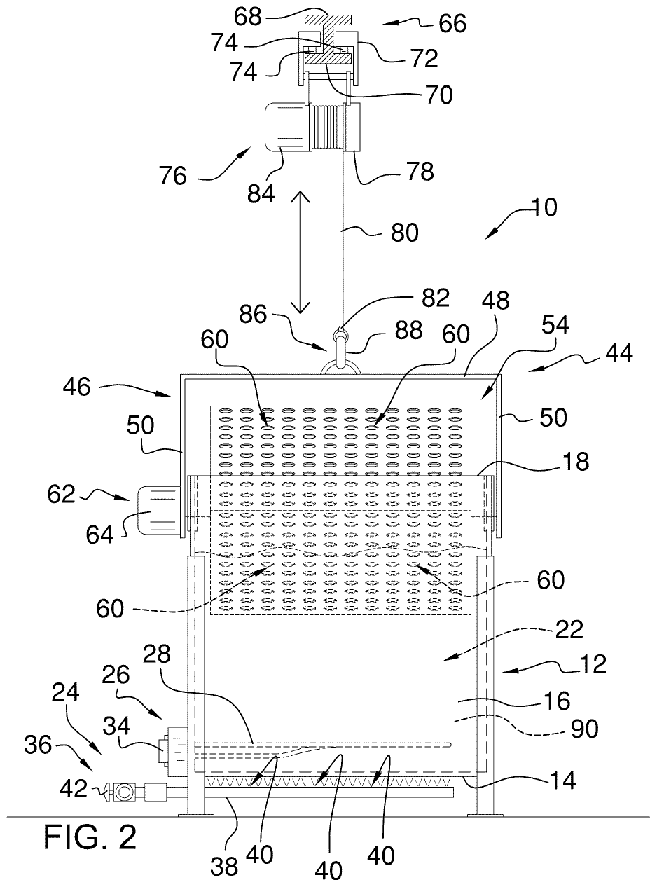

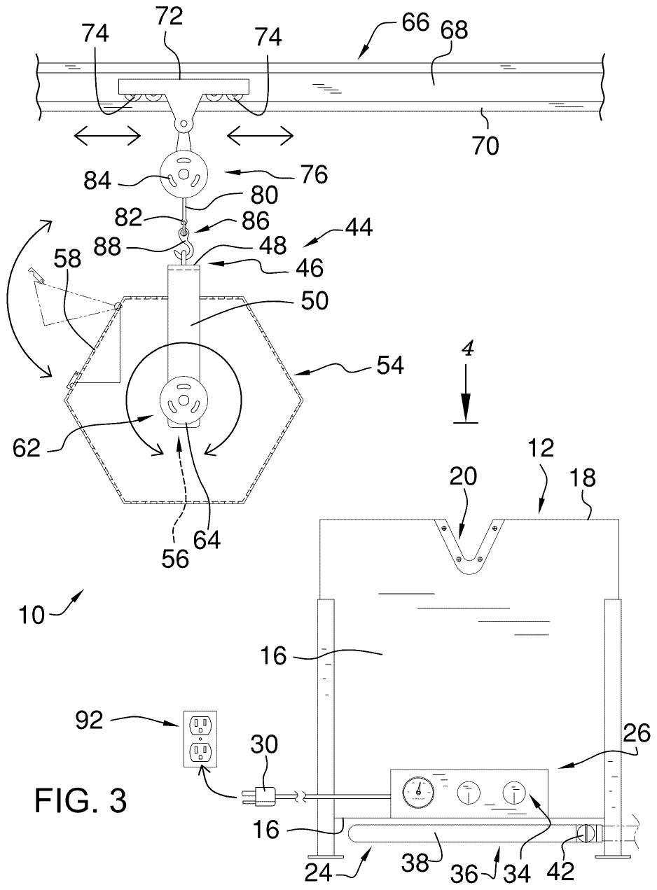

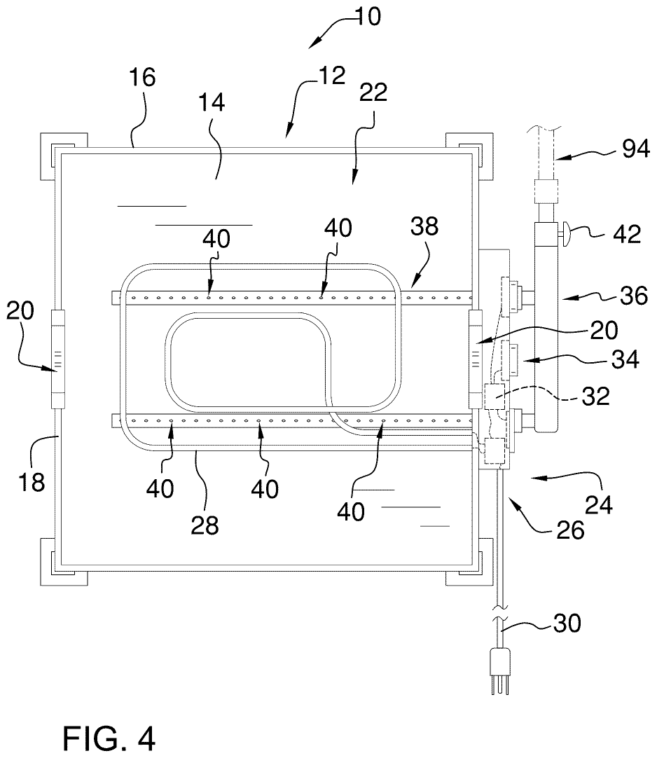

With reference now to the drawings, and in particular to FIGS. 1 through 4 thereof, a new oil-frying cooking apparatus embodying the principles and concepts of an embodiment of the disclosure and generally designated by the reference numeral 10 will be described.

As best illustrated in FIGS. 1 through 4, the cooking apparatus 10 generally comprises a vessel 12 with a base wall 14 and a perimeter wall 16, wherein the perimeter wall 16 is coupled to and extends away from the base wall 14. The vessel 12 defines a cavity 22 which is surrounded by the base wall 14 and the perimeter wall 16. The vessel 12 is configured to contain cooking oil 90 in the cavity 22. The perimeter wall 16 defines a pair of notches 20 in an upper edge 18 of the perimeter wall 16. The notches 20 are positioned opposite each other across the cavity 22.

A heating assembly 24 is provided for heating the cooking oil 90. The heating assembly 24 comprises an electrical heater 26 and a gas heater 36. Though, in other embodiments, only one of the heaters 26, 36 may be used, or another suitable heat source may be used. The electrical heater 26 comprises a resistive heating element 28 which is positioned in the cavity 22 of the vessel 12 and an electrical connector 30 which is electrically coupled to the resistive heating element 28. The electrical connector 30 is configured to electrically couple to an external power source 92. The electrical heater 26 also includes a processor 32 and an input 34. The processor 32 is operatively coupled to the resistive heating element 28 and the electrical connector 30, and the processor 32 is programmed to adjust an electrical current flowing through the resistive heating element 28 in order to adjust a rate at which the resistive heating element 28 emits heat for heating the cooking oil 90. The input 34 is operatively coupled to the processor 32.

The gas heater 36 comprises tubing 38 which is positioned adjacently below the vessel 12. The tubing 38 is configured to be in fluid communication with a gas supply 94, and the gas heater 36 includes a control valve 42 which is coupled to the tubing 38 to control a flow rate of a gas through the tubing 38. The tubing 38 defines a plurality of outlets 40 for releasing the gas which flows from the gas supply 94. When ignited, the gas will heat the vessel 12 and the cooking oil 90 contained therein. Sensors for determining heat rate, temperature of the cooking oil 90, or the like may be provided in the heating assembly 24, and gauges or displays or the like may be provided for displaying the parameters detected or measured by the sensors.

A food container 44 is provided and is movable with respect to the vessel 12. The food container 44 comprises a frame 46 and a fryer basket 54 rotatably mounted to the frame 46. The frame 46 has a top member 48 and a pair of arms 50, wherein the pair of arms 50 is coupled to and extends downwardly from the top member 48. The arms 50 are spaced from each other, and the fryer basket 54 is mounted to the arms 50 via an axle 52 which is coupled to and extends between the arms 50. The food container 44 is positionable to rest the axle 52 in the notches 20 of the perimeter wall 16 of the vessel 12. When the axle 52 is positioned in the notches 20, at least a portion of the fryer basket 54 is positioned in the cavity 22 of the vessel 12.

The fryer basket 54 defines an interior volume 56 therein and defines a plurality of holes 60 which extend through the fryer basket 54 into the interior volume 56. The fryer basket 54 includes a door 58 for selectively accessing the interior volume 56 from outside the fryer basket 54. A basket drive 62 is configured to selectively rotate the fryer basket 54 with respect to the frame 46. The fryer basket 54 drive comprises a motor 64 mounted to the frame 46 and is rotatably coupled to the fryer basket 54. The fryer basket 54 has a hexagonal prism shape but may have other prism shapes, a cylindrical shape, or other suitable shapes for holding food therein.

A track 66 is spaced above the vessel 12 and extends horizontally with respect to the vessel 12. The track 66 comprises an I-beam 68. A carriage 72 is movably mounted to the track 66, and the food container 44 is mounted to and is spaced below the carriage 72. The carriage 72 hangs from a bottom flange 70 of the I-beam 68. The carriage 72 comprises a plurality of wheels 74 which resting atop the bottom flange 70.

A hoist 76 is coupled to and extends between the carriage 72 and the food container 44. The hoist 76 is configured to alternately raise and lower the food container 44 with respect to the vessel 12. The hoist 76 comprises a spool 78 rotatably mounted to the carriage 72, a hoist motor 84 operatively coupled to the spool 78, and a cord 80. The cord 80 is mounted to the spool 78 such that rotating the spool 78 in a first rotational direction will draw the cord 80 to wind onto the spool 78 and rotating the spool 78 in a second rotational direction opposite the first rotational direction will facilitate the cord 80 unwinding from the spool 78 with sufficient tension pulling on the cord 80. The cord 80 has a distal end 82 with respect to the spool 78 which is coupled to the food container 44 via a connector 86 comprising a hook 88. The hook 88 engages a portion of the frame 46. The connector 86 may comprise a latch, a magnet, a clamp, or the like in other embodiments.

In use, the cooking oil 90 may be positioned in the cavity 22 of the vessel 12 and heated via the heating assembly 24 to a desirable temperature for cooking a selected food item. The selected food item may be placed in the fryer basket 54 and secured therein by closing the door 58 of the fryer basket 54. Then the fryer basket 54 may be placed in the cavity 22 of the vessel 12 such that the axle 52 rests in the notches 20 and atop the perimeter wall 16 of the vessel 12. The perimeter wall 16 helps to support the food container 44 on the vessel 12 and secures the axle 52 from translational movement with respect to the vessel 12. The fryer basket 54 may then be rotated via the fryer basket 54 drive to rotate and mix the selected food item as it cooks in the cooking oil 90. The cooking oil 90 freely enters and exits the fryer basket 54 through the holes 60 of the fryer basket 54.

The fryer basket 54 may be removed from the cooking oil 90 when the selected food item is finished cooking by operating the hoist 76 to lift the food container 44 away from the vessel 12. The food may be removed from the fryer basket 54 via the door 58. The fryer basket 54 may be moved horizontally from the vessel 12 via sliding the carriage 72 along the track 66 before removing the selected food item from the fryer basket 54. In some cases, it may be advantageous to rest the fryer basket 54 on a support surface adjacent to the vessel 12 when adding or removing food from the fryer basket 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking apparatus for oil-frying food, the cooking apparatus comprising:
a vessel comprising a base wall and a perimeter wall, the perimeter wall being coupled to and extending away from the base wall, the vessel defining a cavity which is surrounded by the base wall and the perimeter wall, the vessel being configured to contain cooking oil in the cavity;
a heating assembly mounted to the vessel and configured to heat the cooking oil;
a food container which is movable with respect to the vessel, the food container comprising:
a frame; and
a fryer basket rotatably mounted to the frame, the fryer basket defining an interior volume in the fryer basket, the fryer basket defining a plurality of holes which extend through the basket into the interior volume; and
wherein the food container is positionable in a cooking position in which the fryer basket is positioned in the cavity of the vessel.

2. The cooking apparatus of claim 1, wherein:
the frame of the food container comprises a top member and a pair of arms, the pair of arms coupled to and extending downwardly from the top member, the pair of arms being spaced from each other;
the food container further comprises an axle coupled to the frame, the axle being positionable in the pair of notches of the perimeter wall of the vessel; and
the fryer basket is rotatably mounted to the frame via the axle.

3. The cooking apparatus of claim 2, wherein:
the perimeter wall of the vessel defines a pair of notches in an upper edge of the perimeter wall, the pair of notches being positioned opposite each other;
the fryer basket of the food container is positioned in the cavity of the vessel when the axle is positioned in the pair of notches of the perimeter wall of the vessel.

4. The cooking apparatus of claim 1, wherein the fryer basket includes a door for selectively accessing the interior volume from outside the fryer basket.

5. The cooking apparatus of claim 1, wherein the food container further comprises a basket drive operatively coupled to the fryer basket, the basket drive comprising a motor mounted to the frame and rotatably coupled to the fryer basket.

6. The cooking apparatus of claim 1, wherein the heating assembly comprises an electrical heater comprising:
a resistive heating element, the resistive heating element being positioned in the cavity of the vessel;
an electrical connector electrically coupled to the resistive heating element, the electrical connector being configured to electrically couple to an external power source;
a processor operatively coupled to the resistive heating element and the electrical connector, the processor being programmed to adjust an electrical current flowing through the resistive heating element; and
an input operatively coupled to the processor.

7. The cooking apparatus of claim 1, wherein the heating assembly comprises a gas heater comprising:
tubing positioned adjacently below the vessel, the tubing being configured to be in fluid communication with a gas supply, the tubing defining a plurality of outlets for releasing a gas which flows from the gas supply; and
a control valve coupled to the tubing, the control valve being configured to control a flow rate of the gas.

8. The cooking apparatus of claim 1, further comprising:
a track spaced above the vessel and extending horizontally with respect to the vessel; and
a carriage movably mounted to the track, the food container being mounted to and being spaced below the carriage.

9. The cooking apparatus of claim 8, wherein:
the track comprises an I-beam; and
the carriage hanging from a bottom flange of the I-beam.

10. The cooking apparatus of claim 9, wherein the carriage comprises a plurality of wheels, the plurality of wheels resting atop the bottom flange.

11. The cooking apparatus of claim 8, further comprising a hoist coupled to and extending between the carriage and the food container, the hoist being configured to alternately raise and lower the food container with respect to the vessel.

12. The cooking apparatus of claim 11, wherein the hoist comprises:
a spool rotatably mounted to the carriage;
a hoist motor operatively coupled to the spool; and
a cord mounted to the spool, the cord having a distal end with respect to the spool which is coupled to the food container.

13. The cooking apparatus of claim 12, wherein the hoist further comprises a connector removably coupling the cord to the food container, the connector being mounted to the distal end of the cord.

14. The cooking apparatus of claim 13, wherein the connector comprises a hook.

15. A cooking apparatus for oil-frying food, the cooking apparatus comprising:
a vessel comprising a base wall and a perimeter wall, the perimeter wall being coupled to and extending away from the base wall, the vessel defining a cavity which is surrounded by the base wall and the perimeter wall, the vessel being configured to contain cooking oil in the cavity, the perimeter wall defining a pair of notches in an upper edge of the perimeter wall, the pair of notches being positioned opposite each other;
a heating assembly mounted to the vessel and configured to heat the cooking oil, the heating assembly comprising:
an electrical heater comprising:
a resistive heating element, the resistive heating element being positioned in the cavity of the vessel;
an electrical connector electrically coupled to the resistive heating element, the electrical connector being configured to electrically couple to an external power source;
a processor operatively coupled to the resistive heating element and the electrical connector, the processor being programmed to adjust an electrical current flowing through the resistive heating element; and
an input operatively coupled to the processor; and
a gas heater comprising:
tubing positioned adjacently below the vessel, the tubing being configured to be in fluid communication with a gas supply, the tubing defining a plurality of outlets for releasing a gas which flows from the gas supply; and
a control valve coupled to the tubing, the control valve being configured to control a flow rate of the gas;
a food container which is movable with respect to the vessel, the food container comprising:
a frame, the frame having a top member and a pair of arms, the pair of arms coupled to and extending downwardly from the top member, the pair of arms being spaced from each other;
an axle coupled to the frame, the axle being positionable in the pair of notches of the perimeter wall of the vessel;
a fryer basket rotatably mounted to the frame via the axle, the fryer basket defining an interior volume in the fryer basket, the fryer basket defining a plurality of holes which extend through the basket into the interior volume, the fryer basket being positioned in the cavity of the vessel when the axle is positioned in the pair of notches of the perimeter wall of the vessel, the fryer basket including a door for selectively accessing the interior volume from outside the fryer basket; and
a basket drive operatively coupled to the fryer basket, the basket drive comprising a motor mounted to the frame and rotatably coupled to the fryer basket;
a track spaced above the vessel and extending horizontally with respect to the vessel, the track comprising an I-beam;
a carriage movably mounted to the track, the food container being mounted to and being spaced below the carriage, the carriage hanging from a bottom flange of the I-beam, the carriage comprising a plurality of wheels, the plurality of wheels resting atop the bottom flange; and
a hoist coupled to and extending between the carriage and the food container, the hoist being configured to alternately raise and lower the food container with respect to the vessel, the hoist comprising:
a spool rotatably mounted to the carriage;
a hoist motor operatively coupled to the spool;
a cord mounted to the spool, the cord having a distal end with respect to the spool which is coupled to the food container; and
a connector removably coupling the cord to the food container, the connector being mounted to the distal end of the cord, the connector comprising a hook.
